(19) United States
(12) Patent Application Publication
(10) Pub. No.: US 2004/0241262 A1
(43) Pub. Date: Dec. 2, 2004

(54) Method and apparatus for underfilling electronic components using vacuum assist

(76) Inventors: Brett Huey, San Diego, CA (US); David N Padgett, Carlsbad, CA (US); Horatio Quinones, Vista, CA (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/483,128

(22) PCT Filed: Jul. 8, 2002
(86) PCT No.: PCT/US02/21458

(30) Foreign Application Priority Data
Jul. 9, 2001 (US) 60303855
Jul. 9, 2001 (US) 60303990
Oct. 30, 2001 (US) 60341010
Oct. 30, 2001 (US) 6034011
Oct. 31, 2001 (US) 29151038
Oct. 31, 2001 (US) 60335090
Oct. 31, 2001 (US) 60334682
Jun. 14, 2002 (US) 29162409
Jun. 14, 2002 (US) 29162410

(51) Int. Cl. A23P 1/00

(52) U.S. Cl. 425/110

(57) ABSTRACT

A bead of liquid encapsulant or underfilled material (16) is dispensed along one or more edges of the flip chip (12). A plenum is located along the sides of the chip (12) in which encapsulant or underfilled material has not been deposited, such as opposite the dispensed material. Thereafter, the plenum is subject to a negative pressure source for drawing a vacuum to the area beneath the chip (12) and the substrate (10). The negative pressure aids in the natural capillary underfilling action and for quicker and more effective underfilling of the chip. Simultaneous underfilling of a plurality of chips (12) can be achieved by mounting a like plurality of vacuum tools to a plate which is moved into registration with a like plurality of chip/substrate workstations. By operatively connecting the vacuum tools to a controller, and to appropriate valves which can be set to adjust the vacuum level.

### FIELD OF THE INVENTION

This invention relates to dispensing and dispensing systems for applying materials to substrates. In particular, this invention relates to the dispensing of liquid materials for use in semiconductor package manufacturing. More particularly, this invention relates to a method and apparatus for underfilling a semiconductor device that has been mounted to a substrate, such as for example a circuit board.

### BACKGROUND OF THE INVENTION

In the electronics industry, it is common to electrically and mechanically mount a semiconductor device, i.e., an integrated circuit chip, to a substrate. One such structural arrangement is often referred to as a “flip chip.” A “flip chip” is made in a wafer shape with electrically conductive contacts, or bond pads, directed upwardly. Thereafter, each of the “flip chip” semiconductor devices is separated from the wafer and “flipped” over so that the now-downwardly directed electrical contacts can be electrically connected to corresponding contacts on a substrate. A typical electrical connection includes contact between solder bumps on the substrate and bond pads on the active surface of the flip chip. In many cases the bumps and/or the bond pads are reflowed to form a solder joint between the flip chip semiconductor device and the substrate. This results in a gap between the semiconductor device and the substrate.

The semiconductor device and the substrate are usually formed of different materials which have different mechanical properties, and as a result, they react differently to operating conditions and mechanical loading. This situation creates stresses on the electrical connections between the semiconductor device and the substrate. As a result, to strengthen and reinforce the mechanical connection between the semiconductor device and the substrate, it is common in the electronics industry to fill the gap between the semiconductor device and the substrate with an encapsulating fill material.

As the electronics industry moves toward larger size chips and smaller gap dimensions, the time necessary to encapsulate and/or fill becomes longer and less cost effective. Moreover, as the spacing of the electrical connections becomes more dense, the potential for creating voids in the underfill, i.e., pockets where there is no encapsulant material, becomes greater. The existence of voids within the encapsulant material weakens the entire structure, adversely effecting the reliability of the final product.

It is an object of the present invention to improve the durability and reliability of electronic components which require an underfill encapsulant material in the gap between a chip mounted on a substrate.

It is another object of the invention to reduce the time required to effectively and reliably underfill encapsulant material within the gap between an integrated circuit chip mounted on a substrate.

It is still another object of the invention to improve upon the reliability and control of an underfill operation which is necessary for encapsulating the electrical connections extending between an integrated circuit chip and a substrate to which it is mounted, particularly as the electronics industry moves toward large chip sizes, smaller gaps and denser electrical connections.

It is still another object of the invention to improve upon the overall throughput, or manufacturing capacity, of substrate chip technology, while at the same time accommodating the need for flexibility and also accommodating different chip sizes, smaller gap dimensions, and the various types of liquid encapsulant used in the industry.

### SUMMARY OF INVENTION

The present invention achieves the above stated objects by applying vacuum pressure to assist the capillary action of an encapsulant underfilling material. As used herein, the terms “vacuum” or “vacuum pressure” are intended to mean a pressure below atmospheric pressure, i.e., a negative pressure. Vacuum pressure is applied to a partially open plenum of a tool located proximate an edge of an integrated circuit chip. The plenum communicates with a gap between the chip and the substrate and is preferably multi-legged. For example, it may be L-shaped with two legs or it may be U-shaped with three legs. A pressure drop is formed between the plenum and atmosphere and this pressure drop helps to draw the encapsulant fluid material into the gap from a generally opposite side of the chip. The pressure differential or drop assists the capillary action of the encapsulant to significantly decrease the underfilling time in comparison to capillary action used alone.

This invention is adaptable to a number of different underfill situations, depending upon the type of liquid encapsulant material that is used and/or the size and shape of the chip and/or the gap. For instance, the tool may include multiple vacuum ports for applying negative pressure to the plenum. The use of multiple ports enables different magnitudes of negative pressure to be applied to different areas of the plenum, thereby to achieve desired flow characteristics in the gap beneath the chip. If desired, the plenum can be partitioned with internal walls, with a vacuum port and negative pressure source dedicated to each partition of the tool. The amount and the duration of negative pressure will depend on a number of factors, including the encapsulant material, the gap dimension, and the size of the chip, to name a few.

According to another aspect of the invention, the tool may include an insert which is oriented generally parallel with the substrate and the chip, to divide the plenum into upper and lower regions. The insert includes a plurality of holes to distribute to the lower region, the negative pressure applied to the upper region, in a desired pattern which depends on the size and spacing of the holes.

According to one embodiment of the invention, with an integrated circuit chip mounted to a substrate, and a gap therebetween, a bead of liquid encapsulant material is deposited preferably in a continuous manner along two or more side edges of the chip. Thereafter, a vacuum tool is located on generally the opposite side of the chip to communicate negative pressure to the gap between the substrate and the chip. With negative pressure applied to the plenum, via at least one port formed in the walls of the tool, a pressure drop is formed between the plenum and atmosphere. Since the plenum communicates with the gap underneath the chip, the negative pressure aids the natural capillary underfilling action and promotes quicker and more effective underfilling of the chip.

According to still another embodiment of the invention, a plurality of vacuum tools are mounted on a mounting member such as a plate in a desired orientation and the plate is movable into registration with a like plurality of chips mounted on substrates, i.e., chip/substrate work stations. Each vacuum tool operatively connects, via a plurality of vacuum lines, to a negative pressure source and a controller. The controller enables an operator to selectively control the level of negative pressure to be applied to the plenum, and also the rate at which the negative pressure is to be applied or removed from the plenum. As another alternative to this embodiment, a mounting member or plate includes multiple vacuum supply ports communicating with suitable openings or slots on one side of the plate which are configured to respectively communicate negative pressure to the tools. This embodiment eliminates the need for multiple vacuum lines and fittings coupled to each of the tools and results in a more cost effective manufacturing system.

These automated versions of the invention increase manufacturing throughput of flip chips because the underfilling process simultaneously occurs at a plurality of chip/substrate work stations. Moreover, the negative pressure and the controller provide for selective control of the simultaneous underfilling at the plurality of work stations. This arrangement promotes not only improved manufacturing capacity, but also improves manufacturing capacity in a manner which flexibly accommodates a number of different considerations, such as chip size, gap dimension, type or viscosity of encapsulant. According to further variations of this embodiment, the controls can be arranged such that different negative pressure levels and different rates for applying or removing the negative pressure levels can be used for different portions of the same plenum, to achieve a desired flow pattern within the gap. For instance, with a square shaped chip it may be desired for the vacuum applied to the center of the plenum to be greater, because the encapsulant must flow a greater distance to reach the center of the tool.

According to yet another embodiment of the invention, with an integrated circuit chip mounted to a substrate, a bead of liquid encapsulant or underfill material is deposited preferably in a continuous manner along one or more side edges of the chip. Thereafter, a multi-chambered plenum tool is located on generally the opposite side of the chip to communicate negative pressure to the area between the substrate and the chip. With negative pressure applied to the chambers of plenum, a pressure drop is formed between the plenum and atmosphere. Since the plenum communicates with the area underneath the chip, the negative pressure aids the natural capillary underfilling action and promotes quicker and more effective underfilling of the chip. The intake of air into the plenum is controlled by allowing the location of the air intake to change during the underfill process.

These and other features of the invention will be more readily understood in view of the following detailed description and the drawings.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of an L-shaped vacuum tool used in accordance with one embodiment of the invention, and also showing an integrated circuit chip mounted to a substrate.

FIG. 2 is a top plan view of the tool, chip and substrate shown in FIG. 1.

FIG. 3 is a cross-sectional view taken along lines 3-3 of FIG. 2.

FIG. 3A is a cross-sectional view taken along lines 3A-3A of FIG. 2.

FIG. 4 is a cross-sectional view similar to FIG. 3 but showing a further progression of the underfilling process.

FIG. 5 is a plan view of the bottom of a vacuum tool used in accordance with another embodiment of the invention.

FIG. 6 is a perspective view of vacuum tool used in accordance with yet another embodiment of the invention.

FIG. 7 is an exploded view of the tool shown in FIG. 6.

FIG. 8 is a cross-sectional view taken along lines B-8 of FIG. 6.

FIG. 9 is a perspective view of a vacuum tool used in accordance with still another embodiment of the invention.

FIG. 10 is a flowchart which schematically shows a control arrangement for controlling the negative pressure applied to a vacuum tool in accordance with an automated embodiment of the invention.

FIG. 11 shows, in exploded view, a vacuum tool for use in accordance with another embodiment of the invention.

FIG. 12 shows, in perspective view, an assembled tool of the type shown in FIG. 11.

FIG. 13 shows, in perspective view, a plurality of the tools of the type shown in FIG. 12, with the tools secured to a plate to facilitate automated and simultaneous underfilling of a plurality of electrical components at a plurality of workstations.

FIG. 14 is a perspective view showing an alternative embodiment to that of FIG. 13 which utilizes a plate with integrated vacuum passages.

FIG. 15 is a side elevational view of the apparatus shown in FIG. 14.

FIG. 16 is a perspective view of the plate shown in FIG. 14, but with the various vacuum tools removed for clarity.

FIG. 17 is a top view of one of the vacuum tools illustrated in FIG. 14.

FIG. 18 is a cross sectional view taken along line 18-18 of FIG. 17.

FIG. 19 is a bottom view of the tool shown in FIG. 17.

FIG. 20 is a schematic diagram of a vacuum tool in accordance with another embodiment of the present invention, and also showing an integrated circuit chip mounted to a substrate and an encapsulant material dispenser.

FIG. 21 is a perspective view of the vacuum tool of FIG. 20, showing its multi-chamber plenum in conjunction with the integrated circuit chip.

FIG. 22 is a cross-section taken generally along line 22-22 of FIG. 21.

FIG. 23 is a top plan view of the embodiment of FIG. 21.

FIG. 24 is an enlarged fragmentary view taken generally along lines 24-24 of FIG. 23.

FIGS. 25 through 28 are partial cross-section views of the multi-chamber plenum of FIG. 23.

FIG. 29 is a cross-sectional view of an alternative multi-chambered plenum.

FIG. 30 is a cross-sectional view of an alternative embodiment of a multi-chambered plenum.

### DETAILED DESCRIPTION OF THE PREFERRED EMBODIMENTS

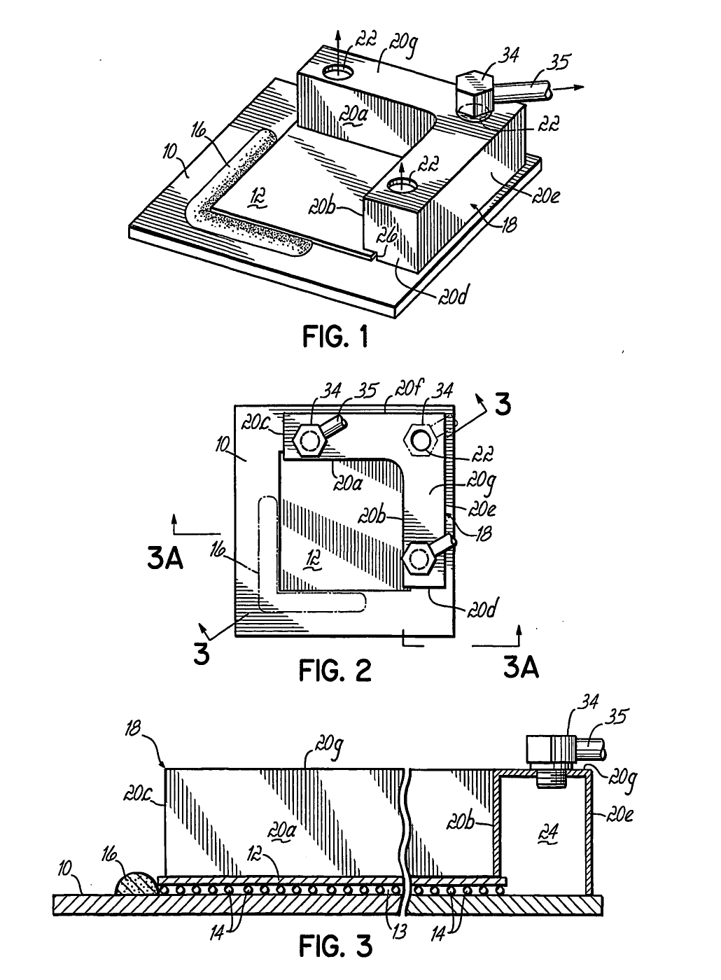

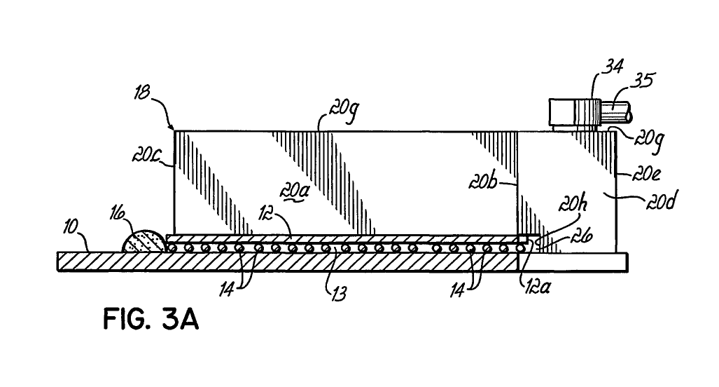

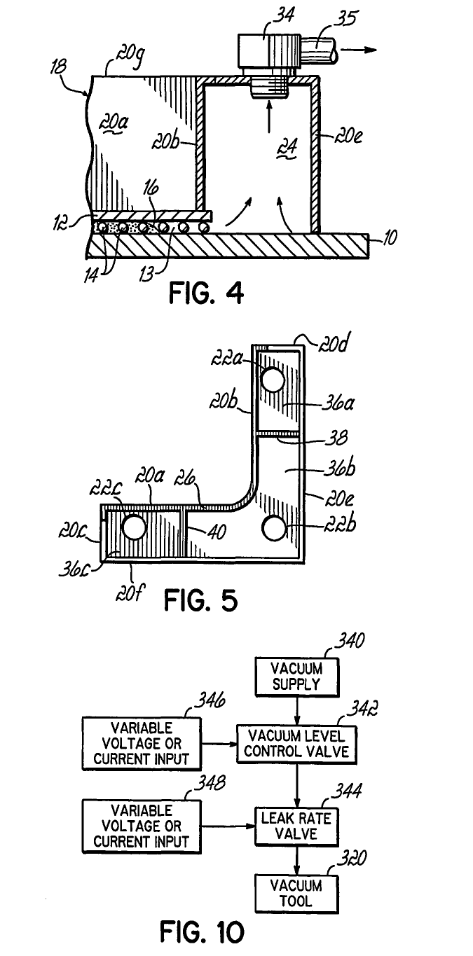

FIG. 1 schematically shows one embodiment of the present invention, which is used to underfill the gap between a substrate 10 and an integrated circuit chip, or die 12. The substrate 10 may comprise an organic or ceramic substrate material such as a printed circuit board, a flip chip multi-chip module, or a flip chip carrier. The gap 13 between the chip 12 and the substrate 10 is better seen in FIGS. 3 and 4, and this gap 13 is defined by electrically conductive solder bumps 14 which electrically and mechanically connect the chip 12 to the substrate 10.

FIG. 1 also shows a liquid encapsulant material 16 applied in an L-shaped bead to the substrate 10 along two side edges of the chip 12. A tool 18 is located along the opposite two side edges of the chip 12, and in a manner such that the tool 18 contacts, i.e., rests on, the substrate 10. It is preferred that the tool 18 is able to extend along portions of two sides of the chip 12. As a result, it is preferred that the tool 18 is generally “L”-shaped, although other configurations could be employed. For example, a bead may be applied along only one edge of the chip 12. In such cases, the tool may be U-shaped as opposed to L-shaped. There may be other structures which could be used to effectively achieve the same objective. The tool 18 is defined primarily by walls 20, and particularly by internal perimeter walls 20a and 20b, end walls 20c and 20d, and external perimeter walls 20e and 20f, along with top wall 20g, which is oriented generally parallel with the substrate 10 and the chip 12. These walls 20, along with one or more ports 22, define an internal cavity, or plenum 24 which is more clearly shown in FIGS. 3 and 4. The shape of the end walls 20c and 20d keep the tool 18 from contacting the chip 12. The tool 20, and particularly the walls of the tool, may be formed out of any suitable material which is sufficiently rigid to withstand the rigors of a manufacturing environment, such as aluminum with a suitable sealing material along lower edges thereof as will be discussed below in connection with another embodiment.

As shown in FIG. 1, and perhaps more clearly shown in FIG. 2, the walls 20 and the tool 18 are sized and dimensioned such that plenum 24 (FIG. 3) extends over the outer perimeter of the chip 12, but need not tightly seal against the chip 12. A very slight gap (not shown) may exist between the upper surface of the chip 12 and the internal perimeter walls 20a and 20b. Such a gap is not so large as to prevent a sufficient pressure drop to be formed between plenum 24 and atmosphere. In accordance with preferred embodiments, this pressure differential is between 25 and 300 Torr. However, depending on the application needs, other higher or lower pressure differentials can be useful as well.

A bead of liquid encapsulant material 16 is placed in an L-shape on the substrate 10 and adjacent two adjacent edges of chip 12 (FIGS. 1 and 2). Vacuum is applied to one or more ports 22 through fittings 34 and conduits 35, and a negative pressure is thereby created within the plenum 24. This pressure drop in the plenum 24 is communicated to gap 13 located between substrate 10 and chip 12. This pressure drop, coupled with the normal capillary action, causes encapsulant 16 to flow under the chip 12 and into the gap 13. As shown in FIG. 3A, a gap 26 is provided between side edges 12a of chip 12 and inset side edges 20h (only one shown) of end walls 20c, 20d. Gap 26 helps keep chip 12 and tool 18 clean by preventing encapsulant 16 from wicking upward at these locations. That is, gap 26 provides for slight air leakage into plenum 24. The air leakage is sufficient to keep tool 18 clean, but not so large as to prevent the generation of a pressure drop in plenum 24 sufficient to draw encapsulant 16 under chip 12 and into gap 13. In this embodiment a fitting or fluid coupling 34 and suitable conduit is used to communicate vacuum to plenum 24.

FIG. 5 shows a slight internal modification to the tool 18. More specifically, FIG. 5 shows tool 18 having three ports 22a, 22b and 22c which correspond to three partitions 36a, 36b and 36c, respectively of the plenum 24. The partitions are defined by internal walls 38 and 40.

The use of multiple ports 22a, 22b and 22c with a corresponding number of partitions 36a, 36b and 36c in the plenum 24 enables the vacuum to be selectively controlled, depending upon the shape or size of the chip 12, the gap 13 between the chip 12 and the substrate 10 (FIG. 3), and/or the type of encapsulant, to achieve flow characteristics which are considered optimal for a particular situation.

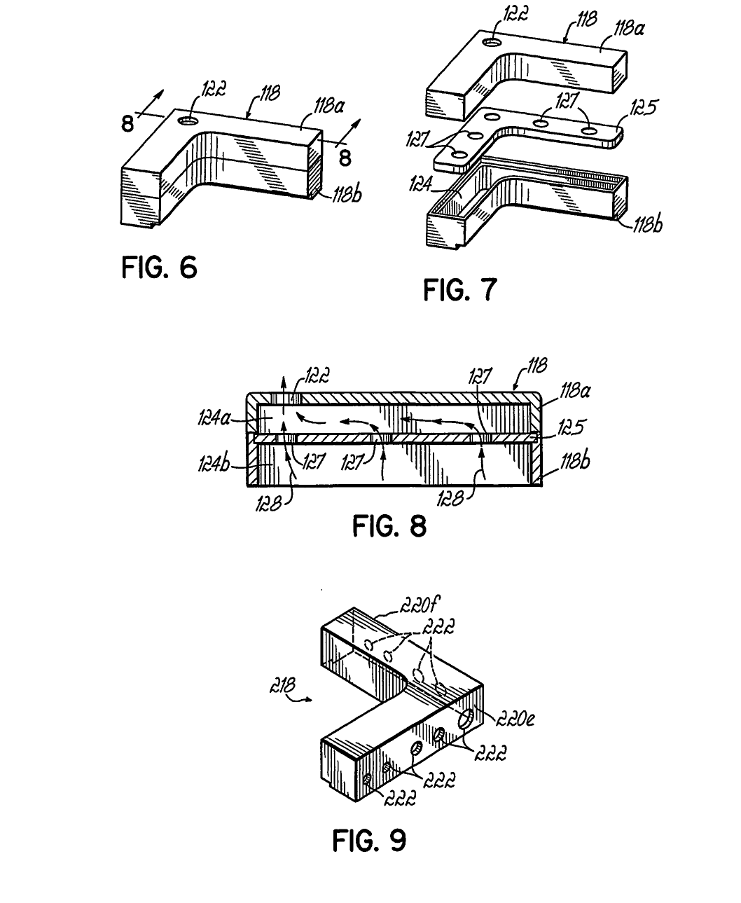

FIGS. 6-9 show additional structural variation of the invention, for enhancing the adaptability of the application of negative pressure to underfill the liquid encapsulant material in the gap 13 between the chip 12 and the substrate 10 (FIG. 3). More specifically, FIG. 6 shows a tool 118 which includes upper and lower sections 118a and 118b which when joined, form walls similar in shape to the walls of tool 18 shown in FIGS. 1-5. Tool 118 has a vacuum port 122, which defines an internal cavity or plenum 124, which is shown in FIG. 7. FIG. 7 also shows that the tool 118 further includes a plenum insert 125, which divides the plenum 124 into upper and lower regions 124a and 124b, respectively. The plenum insert 125 also includes a plurality of spaced holes 127 which place the upper and lower plenum regions 124a and 124b in fluid communication with each other.

Moreover, as shown more clearly in FIG. 8, the plenum insert 125, and particularly the holes 127 distributed along the plenum Insert 125, distribute to plenum section 124b the vacuum which is applied to the tool 118 via the port 122. This distribution is shown by directional arrows 128. The size and spacing of the holes 127 may be varied, as desired, to achieve a desired distribution of the vacuum applied to the lower plenum region 124b, thereby to cause a desired flow pattern of liquid encapsulant material 16 within the gap 13 (FIG. 3).

FIG. 9 illustrates a further aspect of the versatility of the present invention. More particularly, FIG. 9 shows another structural variation of the invention, wherein a similarly shaped tool 218 has vacuum ports 222 formed in outer perimeter walls 220e and 220f. Depending upon the size of the chip 12, the size of the gap 13 between the chip 12 and the substrate 10, the liquid encapsulant material 16, it may be desirable to apply the negative pressure to the tool 218 in a direction which is generally parallel to the surfaces of the substrate 10 and the chip 12 (FIG. 3). Tool 218 provides a structure for doing that. Moreover, the size and spacing of the holes 222 can again be chosen to selectively vary the distribution of the negative pressure which is applied to the plenum 224, thereby to achieve a desired flow affect within the gap 13 between the chip 12 and the substrate 10.

FIGS. 10-13 schematically illustrate the details and controls contemplated by another embodiment of the invention, including the ability for simultaneously underfilling a plurality of chips 12 (FIGS. 1-3). This embodiment of the invention enables the principles of this inventive underfilling process to be more further automated and selectively controlled in order to increase manufacturing throughput.

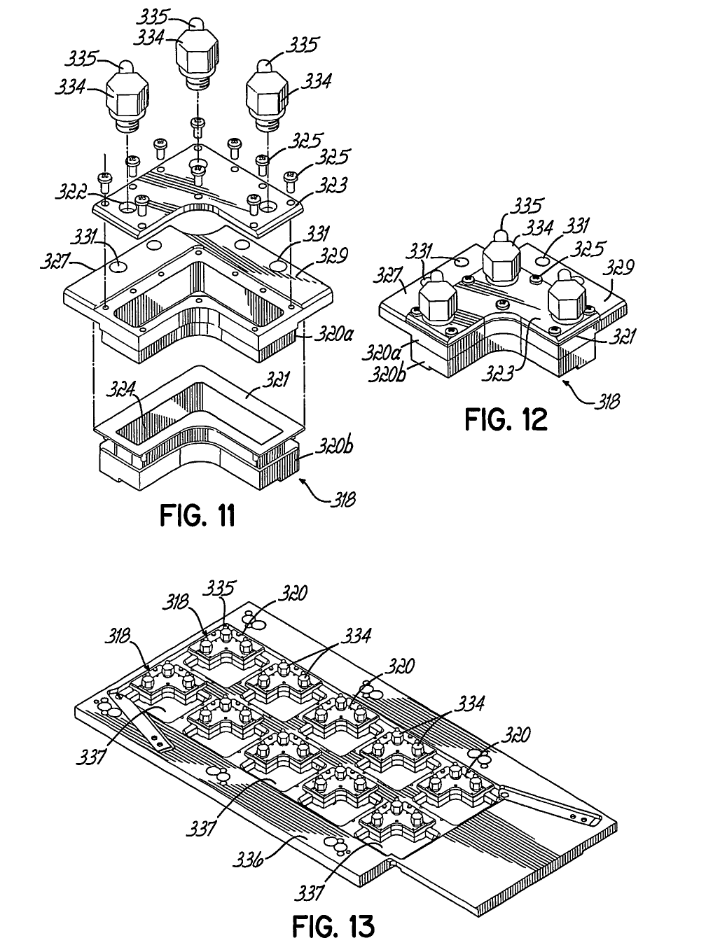

FIGS. 11 and 12 show, in exploded view and in a perspective view, respectively, a tool 318 contemplated by this embodiment of the invention. The tool 318 includes upper and lower base sections 320a and 320b, which are respectively made of aluminum and silicone. Although shown in FIG. 11 in exploded form for clarity, a gasket 321 is preferably integrally molded within the base sections 320a, to provide a fluid tight seal within the tool 318 to maximize the effectiveness of the vacuum applied to the plenum 324 defined thereby. Alternatively, gasket 321 may be formed as a separate boot which is pressed into place within base section 320a, or it may be formed in other suitable manners. Applicant has used silicone to form this gasket 321 as well as the remaining portions of base section 320b, although other materials would be suitable. An upper piece 323 is secured to the top of tool 318, preferably by screws 325 driven through seal 321. The upper piece 323 may be made of a clear transparent material, such as polycarbonate. The upper piece 323 has at least one vacuum port 322 formed therein, and in this case three vacuum ports 322 are shown. Correspondingly, three fittings 334 secure to the tool 318 at the three ports 322, and the three fittings 334 with three corresponding vacuum line connecting portions 335. FIG. 12 shows these components in assembled form.

FIGS. 11 and 12 also show that upper section 320a includes outer flanges 327 and 329, which have bores 331 formed therethrough. Flanges 327 and 329, along with the corresponding bores 331, are used to mount the tool 318 to a plate 336, as shown in FIG. 13. The plate 336 includes a plurality of framed openings 337. FIG. 13 shows the plate 336 with ten such openings 337. The number of such openings 337 corresponds to the number of chip/substrate workstations which will be moved, in a relative manner, into registration with the openings 337, so that simultaneous underfilling may occur at a plurality of identically arranged chip/substrate workstations.

To do this, the plate itself 336 includes holes (not shown) which are aligned with the screws 325 to enable the tool 318 to be secured in proper position within the opening 337. Although only shown in exemplary fashion with respect to one of the tools 318, each of the tools 318 has three ports 322, and three fittings 334 with three corresponding vacuum line connecting portions 335 for allowing coupling with vacuum lines (not shown).

As is shown more clearly in FIG. 10, this automated embodiment of the invention contemplates automated control of the underfill process, for one chip/substrate or as it occurs simultaneously at a plurality of chip/substrate workstations. More specifically, a negative pressure source or vacuum supply 340 operatively connects to each of the portions 335 of fittings 334, with a vacuum level control valve 342 and a leak rate valve 344 operatively connected therebetween. A variable electrical input 346, to vary either voltage or current, operatively connects to the vacuum level control valve 342. A variable electrical input 348, again to vary either electrical current or electrical voltage, operatively connects to the leak rate valve 344.

By adjusting the electrical input 346 to the control valve 342, an operator can select the amount of negative pressure to be applied to the plenum 324 of the vacuum tool 318. Moreover, via selective control of the electrical input 348, the operator can also control the leak rate valve 344, to selectively control the rate at which negative pressure is applied to or removed from the plenum 324. This means that the applied negative pressure can be either “ramped up” or “ramped down,” as desired.

Moreover, if to achieve a desired flow pattern for each of the tools 318 it is desired to apply different amounts of negative pressure to different portions of the plenum 324, such as a greater amount of negative pressure at the center of the plenum 324, then this vacuum control arrangement can be used to separately control the negative pressure applied via each fitting 334. For instance, the negative pressure applied at the center of the plenum 324 may be set at a higher level, and ramped up or ramped down at different rates, than the negative pressure applied at the outer ends of the plenum 324. Further degrees of control can be accomplished by varying the tool 318, according to the different combinations shown in FIGS. 5-9.

Thus, the different fittings 334 of the tools 318 could be operatively connected to a controller which has the capability of simultaneously controlling the application of different amounts of vacuum, and different “ramp up” or “ramp down” rates, to achieve a desired flow pattern. The provision of multiple ports 322 and fittings 334 or vacuum inputs helps balance the air flow so that the liquid encapsulant material is able to be better drawn into the gap 13 between the chip 12 and substrate 10 (FIG. 3) so as to eliminate voids.

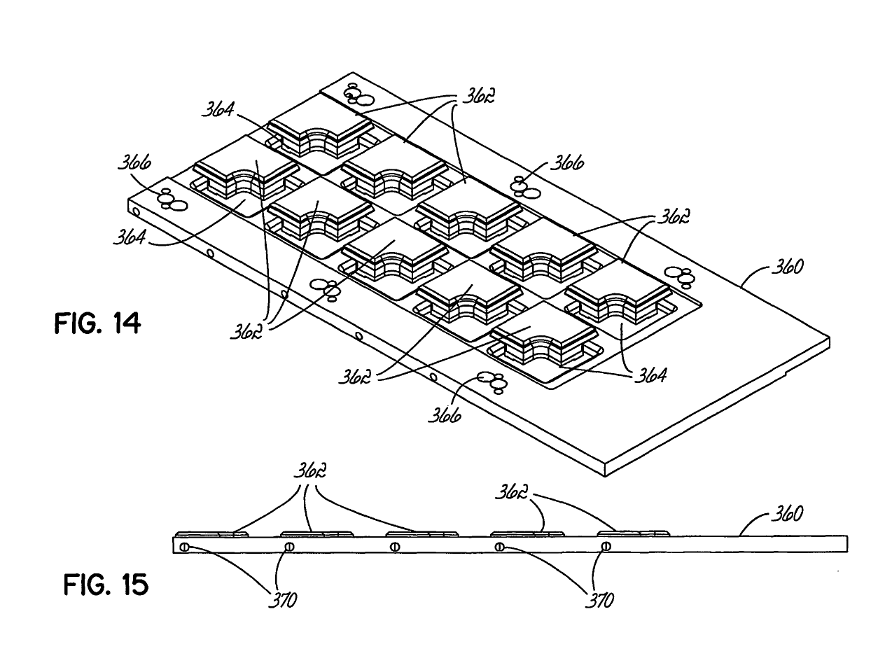

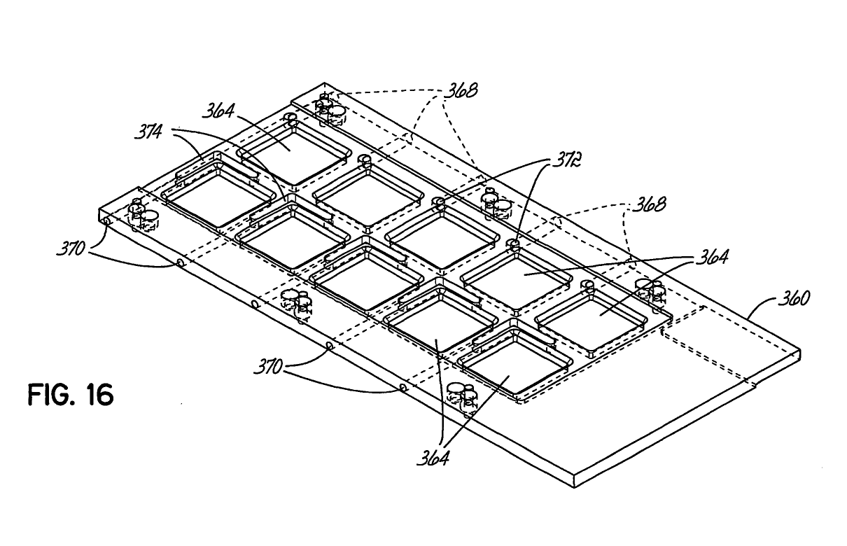

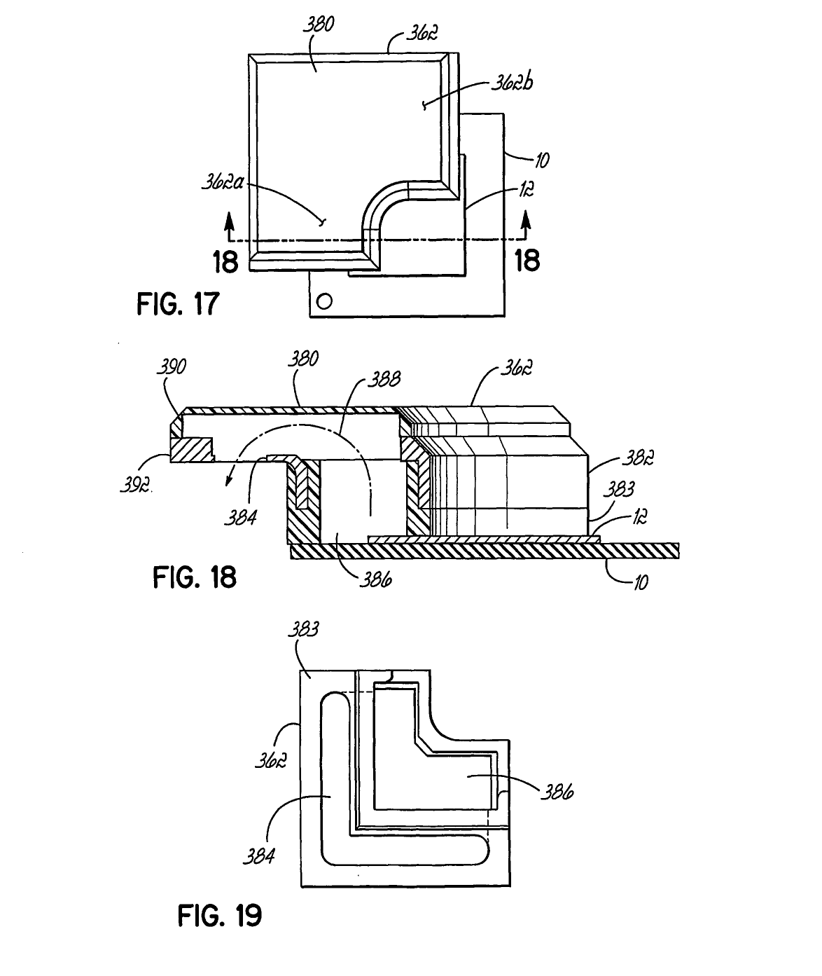

FIGS. 14-16 illustrate an alternative tooling assembly to that shown in FIG. 13 and including a plate 360 configured to hold multiple vacuum tools 362 and a corresponding number of substrates 10 and chips 12 (FIGS. 17, 18). Vacuum tools 362 may be substituted with other forms of tools within the scope of this disclosure as appropriate or desired. As compared to the embodiment shown in FIG. 13, this embodiment eliminates the need for multiple fittings and separate conduits for communicating the negative pressure to the tools 362. Plate 360 includes through openings 364 for receiving the respective chips and substrates, as previously described with respect to FIG. 13, and suitable mounting holes 366 for securing plate 360 to the necessary support structure, such as a conveyor (not shown). The respective chips and substrates are moved into the through openings 364 from beneath plate 360 such that they may be subject to negative pressure applied by tools 362 generally as described with respect to the previous embodiments and as will be further described below. Plate 360 includes respective vacuum supply passages 368, 370 (FIG. 16). Two alternatives are shown. On one side of plate 360, passages 368 communicate with circular ports 372. In another alternative, and as shown on the other side of plate 360, passages 370 communicate with L-shaped slots 374. In practice, only one of the two alternative configurations will normally be used depending on the application needs. L-shaped slots 374 may provide a more even distribution of vacuum to the plenum within tools 362. As another alternative, multiple passages and ports 372 may be directed to communicate with different portions of the plenum inside each tool 362 such that different levels of vacuum may be applied to different areas of the plenum within each tool 362 generally as described above in the case of using multiple fittings.

FIGS. 17-19 illustrate tool 362 as having a top side 380, a bottom side 383 and generally an L-shape with two legs 362a, 362b. As with the previously described embodiments, this tool may also take other configurations, such as a U-shaped configuration having three legs. The bottom side 383 of tool 362 comprises a seal, such as a silicone seal as described in the previous embodiment. The bottom side includes a slot 384 communicating with a plenum 386. Slot 384 communicates with either port 372, generally at the corner of the slot 384, or with L-shaped slot 374 of plate 360 in which case slot 384 is substantially coextensive with slot 374. Plenum 386 receives negative pressure from slot 384 through a flow path 388 shown in FIG. 18. As further shown in FIG. 18, each tool is preferably formed with a top half 390 of a clear plastic and an intermediate or central portion 392 of rigid material such as aluminum which is co-molded to or otherwise secured to seal 383. Plenum 386 communicates with the gap 13 between substrate 10 and chip 12 (see FIG. 3) to provide a vacuum assisted underfill in the same manner as previously described.

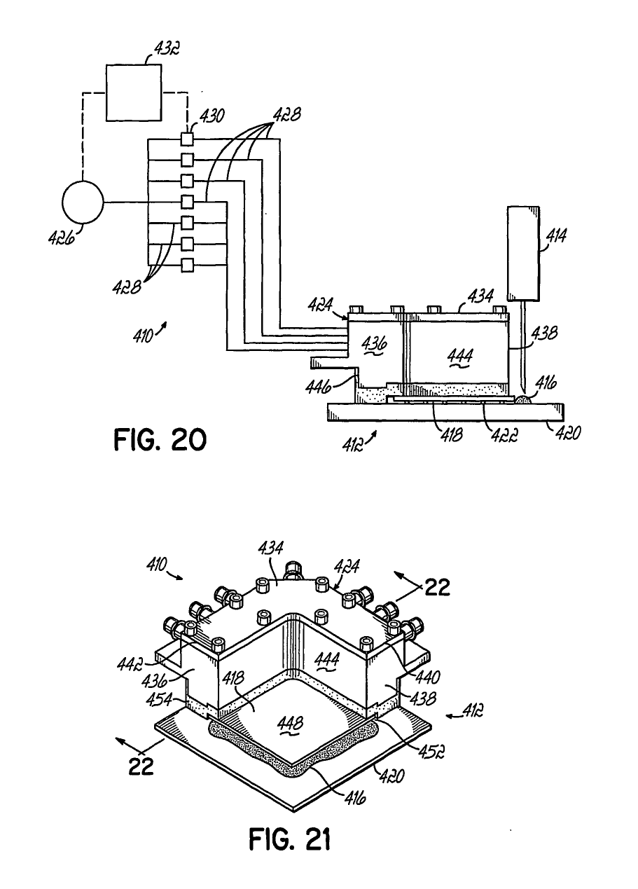

In accordance with another embodiment of the present invention, as illustrated in FIG. 20, there is shown a vacuum tool assembly 410, a semiconductor device package 412 and a dispenser 414 for dispensing underfill material 416. The semiconductor device package 412 may be in the form of a flip chip integrated circuit 418 mounted on a substrate 420, similar to the chip 12 and substrate 10 as described above in connection with the embodiments of FIGS. 1-19. The flip chip 418 may be electrically and mechanically connected to the substrate 420 through a plurality of solder bumps or balls 422 on the underside of the flip chip that are registered or aligned with solder pads on the substrate as described in detail above.

The tool assembly 410 includes a multi-chambered plenum or manifold 424. The chambers of the plenum are coupled to a negative pressure source 426 via a plurality of conduits 428. It is preferred that the flow of the fluid from each chamber be individually controlled as this will give the greatest flexibility in controlling the air flow. As a result, each conduit 428 may include a valve 430. The valves 430 may be ON/OFF type valves, or they may be variable type valves so that the air flow can be readily adjusted or varied. However, it is recognized that more than one chamber can be operated or controlled together. As a result, a valve 430 could control more than one conduit, i.e. more than one chamber. Control of the operation of the valves 430 and the negative pressure source 426, is accomplished via controller 432.

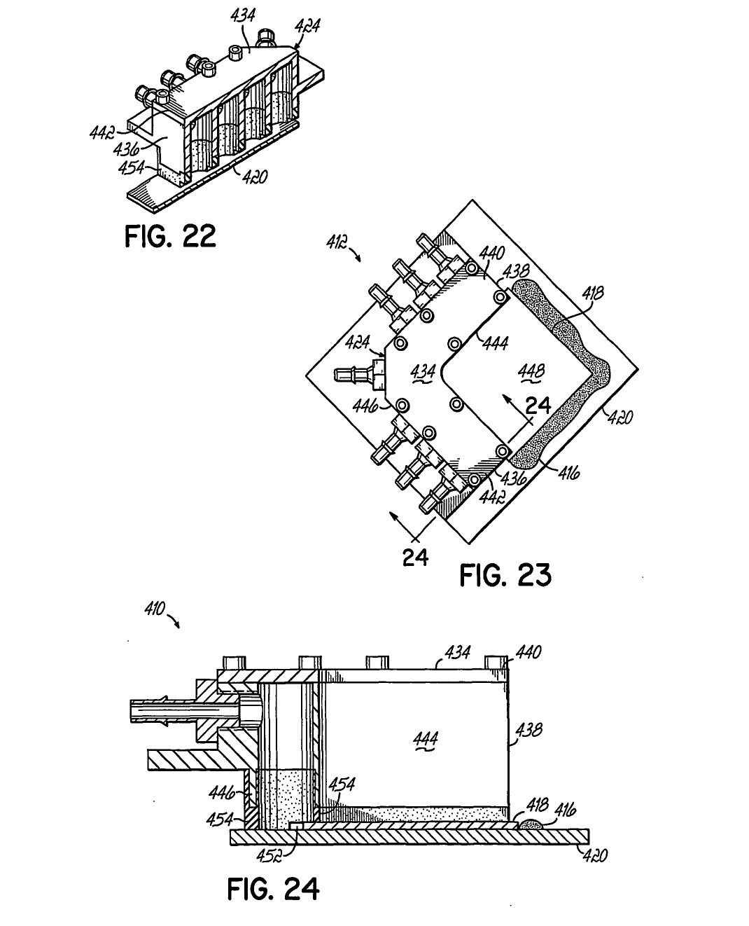

Now, with reference to FIGS. 20 through 24, the plenum 424 may have a substantially “L” shaped top 434, a pair of end walls 436, 438 extending from the ends 440, 442 of the top 434, internal perimeter walls 444, and external perimeter walls 446. Each internal and external perimeter wall 444, 446, respectively, extends from the top 434, and between the end walls 436, 438. Preferably, the internal perimeter wall 444 extends a shorter distance from the top wall 434 than the external perimeter wall 446 does. In operation, the internal perimeter wall 444 extends from the top wall to substantially the top surface 448 of the flip chip 418, while the exterior perimeter wall 446 extends from the top wall to substantially the top surface of the substrate 420. A sealing member 454, such as a gasket, is attached to the bottom of the Interior, exterior and end walls to provide a seal with the top 448 of the chip 418 and the substrate 420 respectively. The gasket may be integrally molded with the walls or it can be releasably attached. For example, the gasket may be pressed into place like a boot. This would allow for the gasket to be readily replaced because of wear, contamination, etc. While the end walls 436, 438 extend substantially to the top of the substrate, the end walls and sealing member 454 are also stepped so as to mate with the internal perimeter wall 444 and to substantially engage the top 448 of the flip chip 418. The step portion of the end walls 436, 438 and sealing member 454 further provides a passageway or gap 452 between the tool assembly 410 and the flip chip 418. This gap 452 allows the end walls 436, 438 and sealing member 454 to be spaced from the chip 418 such that they will not come into contact with the dispense material during the underfill process as described in detail above in connection with the embodiments of FIGS. 1-19. This gap also provides for the passage of air as will be discussed further below. In other words, the spacing should be sized so that the adhesive will not contact or otherwise contaminate the tool, while allowing for the proper free flow of air.

In accordance with this embodiment of the present invention, the plenum 424 includes a number of chambers 456a-g. The exact number of chambers is a function of, but not limited by, the die size and control resolution. In this particular embodiment, the plenum 424 includes seven chambers 456a-g. Again, it is preferred that each plenum 424 is coupled to a negative pressure source 426. Initially, all of the chambers of the plenum 424 are at atmospheric pressure. Once the fluid has been dispensed, the negative pressure source 426 begins to draw a vacuum on all of the chambers so that a sufficient pressure drop is formed between the plenum 424 and atmosphere. At this point, the only air able to enter the plenum 424 is through the passageway or gaps 452. The size of the gaps 452 must be balanced between keeping the tool assembly 410 free from contamination or contact with the dispensing material while still being able to create enough of a pressure drop that allows for the underfill material to be drawn underneath the chip to provide void free underfilling.

The control of the air intake to the various chambers 456a-g of the plenum 424 is controlled in a manner to allow the location of the air intake to change during the underfill process. In other words, the air intake is changed along the periphery of the die 418 as the wave front of the dispensed material propagates underneath the die. Preferably this control is such that as the underfill material reaches the edge of the die 418 underneath the plenum 424, the air intake will not drag the fluid along the outer edge in such a manner that the fluid along the outer edge will outpace the flow front of the fluid underneath the die 418 so that it collapses to form a void. This can be accomplished by moving the location of the air intake along the edge of the die 418 as the underfill material reaches the die's edge. Changing the location of the air intake during the underfill process can be accomplished, for example, by controlling the chambers 456a-g of the plenum to allow them to become the air intake.

At the beginning of a dispensing cycle, all of the chambers 456a-g of the plenum 424 are vented to atmospheric pressure. The encapsulant 416 is dispensed along one or more edges of the chip 418 at which time all of the chambers 456a-g of the plenum 424 are now subjected to the negative pressure source 426. The air is only received into the plenum 424 via gaps 452. Therefore, the air intake is via gaps 452. As the underfill material is drawn under, the chambers 456a-g will sequentially be vented to atmosphere. As a chamber 456a-g is vented to atmosphere, the intake of air will generally be from the vented chamber and not the gap 452. With the proper venting sequence of the chambers 456a-g, the majority of the air intake will lead the flow front of the underfill material and will not allow the air to drag the fluid along the edge of the die or chip 418.

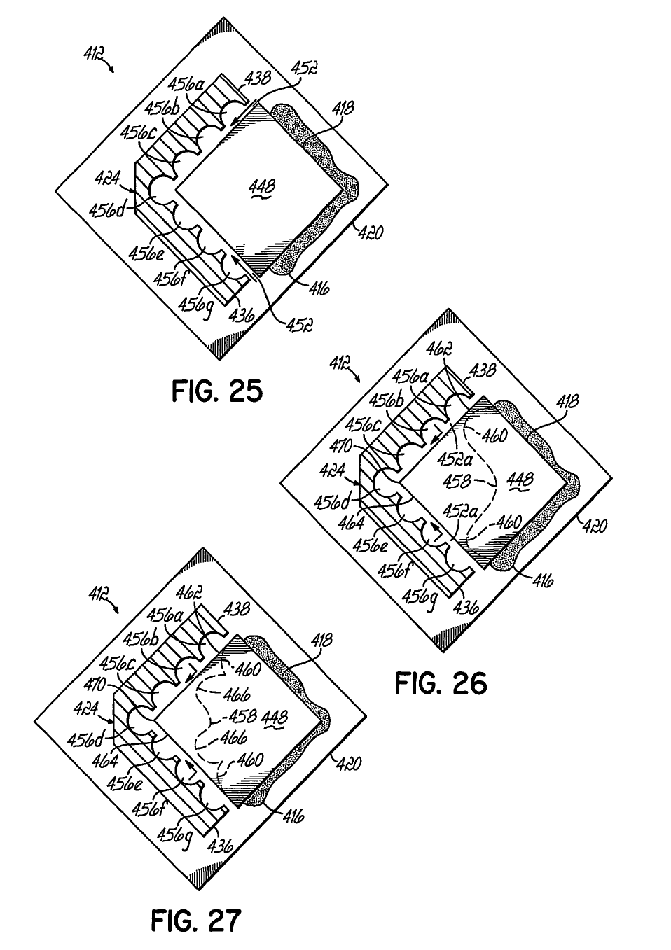

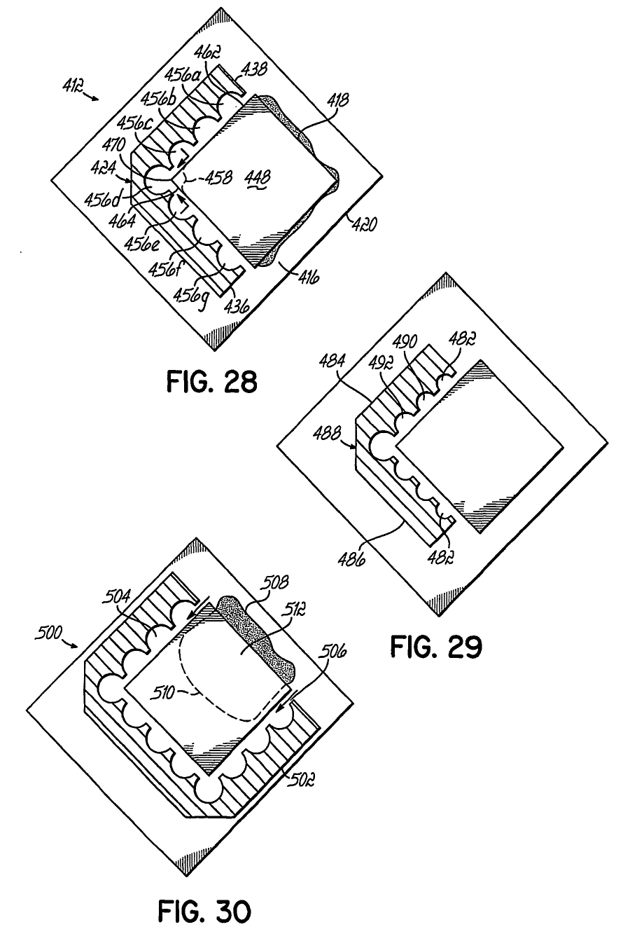

Now, with reference to FIGS. 25 through 28, this process will be described in further detail. Plenum chambers 456a-g are vented to atmospheric pressure. Preferably, the underfill material 416 is dispensed along two adjacent edges of the flip chip 418. Valves 430 are then activated to couple the plenum chambers 456a-g to a source of negative pressure 426. The air intake is then through the gaps 452. The wave front 458 of underfill material 416 is drawn beneath the flip chip 418. As a portion 460 of the wave front 458 reaches the edges 462, 464 of the chip, the associated control valves 430 for chambers 456a and 456g are operated to vent these chambers to atmospheric pressure. Meanwhile, plenum chambers 456b-f are still coupled to the negative pressure source 426. Because of the relative size differential between the plenum chambers 456a, 456g and gaps 452, the predominant source for air intake is the vented plenum chambers 456a and 456g.

A gap 452a exists between adjacent plenum chambers 456a and b. Similar to 452, gap 452a is sized to avoid contamination or coming in contact with the underfill material, as well as sized to balance air flow and pressure drops necessary for complete underfill dispensing. The plenum chambers 456b-f continue to draw a vacuum as the underfill material continues to propagate beneath the chip until portions 466 of the wave front reach the edge of the chip 462, 464 in the vicinity of plenum chambers 456b and 456f. At this time, plenum chambers 456b and f are vented to atmosphere, while plenum chambers 456c-e continue to draw a vacuum. Similarly, as the underfill material reaches the edge of the chip 462, 464 in the vicinity of plenum chambers 456c and 456e, these two chambers are vented to atmosphere leaving only plenum chamber 456d to continue to draw a vacuum. Finally, as the underfill material reaches the corner 470, plenum chamber 456d is finally vented to atmosphere and the chip has been completely underfilled.

Sensors, such as fiber optic sensors, may be employed to determine when the underfill material has reached the edge 462, 464 of the chip in the vicinity of the plenum chambers. As one example, the fiber optic sensor disclosed in U.S. Pat. No. 6,255,142, the disclosure of which is incorporated herein, may be utilized to sense the material. Upon the detection of the material at the edge, the vacuum chamber in that region can then be vented to atmosphere. However, the sequencing of the plenum chambers 456a-g may just as easily be on a time based system. For example, for a known underfill material, substrate and flip chip configuration, etc., it can be determined the time necessary for the underfill material to propagate underneath the chip to reach the vicinity of the respective plenum chamber. As a result, sequential venting of the plenum chambers 456a-g along a edge of the chip, may be such that it is not necessary to sense that the material has actually reached the edge of the chip, but rather plenum chambers 456a and 456g can be vented at time X, plenum chambers 456b and 456f can be vented at time Y, etc. thereby reducing the cost of the ACU assembly, while not diminishing its robustness.

In the above example, the chambers 456a-g of the plenum 424 are controlled in pairs. This may be fine, for example, in the case of a square die with a uniform population of ball and solder pads in which it is desirable to have symmetric flow beneath the die. However, there may be other circumstances in which it may be desirable not to do so, such as where asymmetric flow of the underfill material may be desired. For example, the die may not be square, there may be a non-uniform ball and solder pad distribution beneath the die, etc. In such case, the chambers of one leg of the plenum 424 may not necessarily be controlled In tandem with chambers of the opposite leg of the plenum. In addition, in such asymmetrical flows, it may be envisioned that a number of chambers along an edge of the chip, will not be equal to the number of chambers on the adjacent side of the chip.

In addition, while the chambers 456a-g of the tool assembly 410 are of generally equal cross-sectional area and volume, they may not necessarily be so. It may be desirable, especially in asymmetrical air flow, to utilize chambers of different cross-sectional area and volumes, to achieve the desired distribution of the underfill material. For example, with reference to FIG. 29, the chambers of the plenum 488 could become increasingly larger or graduated, moving from the outer chambers 482 of legs 484, 486 towards the junction of the two legs of the plenum. In other words, chamber 490 would be larger than chamber 482, but smaller than chamber 492.

It will be understood that a plurality of vacuum tools 410 could be mounted on a mounting member such as a plate in a desired orientation and the plate is movable into registration with a like plurality of chips mounted on substrates, i.e., chip/substrate work stations as described in detail above. This version of the invention increases manufacturing throughput of flip chips 418 because the underfilling process simultaneously occurs at a plurality of chip/substrate workstations.

Other configurations of the tool assembly may also be employed, such as a “U” shaped assembly. With reference to FIG. 30, a “U” shaped tool assembly is shown generally as 500. The plenum 502 include a plurality of chambers 504 and gaps 506 as before. The dispensing of the underfill material 508 would only be along one edge of the flip chip. The control of the chambers 504 likewise being in conjunction of the propagation of the underfill 410 beneath the flip chip 512. Chambers 504 would be sequentially vented to atmosphere as the wave front 510 moves towards the far edge 514 of the chip 512. The control of the chambers 504 again will be such that the air flow along the edge of the chip does not drag the underfill material to cause fluid along the outer edge of the chip to outpace the flow front of the underfill material underneath the die so that the material will then collapse on itself to form a void in the underfill material.

While the chambers in the above examples have been controlled in such a manner that they either are vented or are coupled to a vacuum source, as in an ON/OFF type of operation, it is foreseen that it may be desirous to variably control, such as in ramping up or ramping down the chambers.

While this detailed description describes several preferred embodiments of the invention and a number of variations thereof, it will be readily understood by those skilled in the art that the inventive concept is susceptible to numerous other permutations. Applicants do not wish to be limited by the particular structural details shown in these Figures or described in this detailed description. These Figures and this description are meant to be exemplary of the principles of the invention. Moreover, the Figures illustrate the versatility and adaptability of the present invention to a number of structural permutations. This Includes, but is not limited to, the features and/or components of one embodiment being used with other embodiments. Therefore, applicants wish only to be limited by the following claims.

Having described the invention, what is claimed is:

1. An apparatus for underfilling a gap between an integrated circuit chip and a substrate with an encapsulant material to encapsulate a plurality of electrical connections formed therebetween, comprising:
a multi-legged vacuum tool supported on the substrate along at least two peripheral edges of the chip, the tool having walls defining a partially enclosed plenum, whereby the application of negative pressure to the plenum creates a pressure drop between the gap and the plenum to cause flow of encapsulant material into the gap from a location on the substrate along at least one peripheral edge of the chip.

2. The apparatus of claim 1, wherein the tool has at least two ports, and the ports are formed in a wall of the tool located opposite from and generally parallel to the substrate.

3. The apparatus of claim 1, wherein the tool has at least two ports and the ports are located in at least one outer wall of the tool which is oriented perpendicular to the substrate.

4. The apparatus of claim 1, wherein the tool includes at least one internal wall to divide the plenum into more than one partition, with at least one port per partition and negative pressure is applied to each of the partitions to cause underfilling of the encapsulant material.

5. The apparatus of claim 1, wherein the plenum includes an insert oriented generally parallel with the substrate, to divide the plenum into upper and lower regions, the insert having a plurality of holes formed therein, and wherein negative pressure applied to the upper region is conveyed to the lower region via the holes, the holes in the insert being sized and shaped to achieve a desired distribution of the negative pressure from the upper region to the lower region of the plenum.

6. The apparatus of claim 1, wherein the tool includes at least one inset wall portion configured to be spaced from an edge of the chip to thereby allow slight leakage of atmospheric air into the plenum.

7. An apparatus for underfilling a gap between an integrated circuit chip and a substrate, comprising:
a tool having walls with at least one port formed therein and the walls defining a plenum, said tool having multiple legs for extending along multiple edges of the chip and allowing the plenum to communicate with the gap along the multiple legs;
a negative pressure source operatively connected to the plenum via the port so that when a bead of liquid encapsulant is deposited onto the substrate along at least one edge of the chip, a pressure drop is created between the gap and the plenum to cause the liquid encapsulant to flow into the gap toward the plenum and to underfill the chip; and
a controller operatively connected to the negative pressure source and including at least one of a vacuum level control valve to selectively control the level of negative pressure applied to the plenum by the negative pressure source and a valve to selectively control the rate at which the level of negative pressure applied to the plenum is changed.

8. The apparatus of claim 7, wherein the controller includes a variable vacuum control valve which is selectively controlled by an electrical input.

9. The apparatus of claim 7 further comprising:
a mounting plate supporting a plurality of like multi-legged tools, the mounting plate being positionable relative to a like plurality of chips mounted on substrates, and the negative pressure source being operatively connected to the plenum of each of the multi-legged tools and also to the controller, thereby to selectively control the simultaneous underfilling of the plurality of chips.

10. The apparatus of claim 9, wherein each tool has multiple ports and corresponding multiple passages operatively connected to the controller to enable the selective control of the applied negative pressure to differ for different passages depending on the location of the corresponding port relative to the plenum.

11. A method for underfilling an integrated circuit chip supported on a substrate, comprising:
placing a bead of encapsulant material along at least one edge of the chip;
locating a multi-legged tool on the substrate with first and second legs of the tool positioned along at least two remaining edges of the chip, the first and second legs defining at least one plenum adjacent to the chip; and
applying negative pressure to the plenum to cause the flow of encapsulant material to underfill the integrated circuit chip.

12. The method of claim 11, wherein the applying of negative pressure to the plenum occurs via more than one port.

13. The method of claim 11, wherein the tool has at least two ports, and the ports are formed in a wall of the tool located opposite from and generally parallel to the substrate.

14. The method of claim 11, wherein the tool has at least two ports and the ports are located in at least one outer wall of the tool which is oriented perpendicular to the substrate.

15. The method of claim 11, wherein the tool includes at least one internal wall to divide the plenum into more than one partition with at least one port per partition, and negative pressure is applied to each of the partitions to cause underfilling of the encapsulant material.

16. The method of claim 15, wherein the amount of negative pressure applied to the partitions is selected to achieve a desired flow pattern of encapsulant material under the chip.

17. The method of claim 11, wherein the plenum includes an insert oriented generally parallel with the substrate to divide the plenum into upper and lower regions, the insert having a plurality of holes formed therein, and wherein negative pressure applied to the upper region is conveyed to the lower region via the holes, the holes in the insert being sized and shaped to achieve a desired distribution of the negative pressure from the upper region to the lower region of the plenum.

18. The method of claim 11 further comprising:
placing two beads of encapsulant material along two edges of the chip;
locating the legs of the tool along two sides of the chip opposite to the two beads; and
applying negative pressure to the plenum to cause the flow of encapsulant material to underfill the integrated circuit chip.

19. A method of underfilling a gap between an integrated circuit chip and a substrate, comprising:
depositing a continuous bead of liquid encapsulant onto the substrate along at least two side edges of the chip;
placing a multi-legged tool along at least two side edges of the chip, the tool having at least two legs with walls defining a partially enclosed plenum and at least one port; and
applying negative pressure to the plenum via the at least one port to create a pressure drop between the gap and the plenum and cause flow of the liquid encapsulant into the gap.

20. The method of claim 19, wherein the tool includes more than one port, and negative pressure is applied to the plenum via each of the ports.

21. The method of claim 20, wherein the tool includes at least one internal wall to divide the plenum into more than one partition with at least one port per partition, and negative pressure is applied to each of the partitions to cause underfilling of the encapsulant material.

22. The method of claim 22, wherein the amount of negative pressure applied to the partitions is selected to achieve a desired flow pattern of encapsulant material under the chip.

23. The method of claim 19, wherein the plenum includes an insert oriented generally parallel with the substrate to divide the plenum into upper and lower regions, the insert having a plurality of holes formed therein, and wherein negative pressure applied to the upper region is conveyed to the lower region via the holes, the holes in the insert being sized and shaped to achieve a desired distribution of the negative pressure from the upper region to the lower region of the plenum.

24. An integrated circuit chip made according to the process of claim 11.

25. A method of underfilling a gap between an integrated circuit chip and a substrate, comprising:
depositing a continuous bead of liquid encapsulant onto the substrate along at least two side edges of the chip;
placing a multi-legged tool along at least two side edges of the chip, the tool having walls defining a partially enclosed plenum and at least one port; and
applying negative pressure to the plenum via the at least one port to create a drop between the gap and the plenum, and to cause flow of the liquid encapsulant into the gap, wherein the level of negative pressure applied is selectively controlled to effect a desired flow pattern of encapsulant.

26. The method of claim 25, wherein the selective control of the applied negative pressure comprises:
selecting a level of negative pressure to be applied during the applying step; and
controlling a vacuum level control valve to achieve the selected level, the vacuum level control valve being operatively connected to the plenum and the negative pressure source.

27. The method of claim 25, wherein the selective control of the applied negative pressure comprises:
selecting a rate at which the negative pressure is to be applied during the applying step; and
controlling a valve to achieve the selected rate, the valve being operatively connected to the plenum and the negative pressure source.

28. The method of claim 26, wherein the selective control further comprises:
selecting a rate at which the negative pressure is to be applied during the applying step; and
controlling a valve to achieve the selected rate, thereby to selectively control both the level of negative pressure and the rate at which it is applied and removed.

29. The method of claim 25 further comprising simultaneously performing the placing and applying steps at a plurality of work stations via a like plurality of tools mounted on a plate and adapted to be moved into position relative to a like plurality of integrated circuit chips.

30. The method of claim 29, wherein each of the tools includes a plurality of vacuum passages operatively connected to a controller to provide selective control of simultaneous underfilling operations at the plurality of work stations.

31. The method of claim 30, wherein a vacuum level control valve and a valve are operatively connected, via the vacuum passages, to the plurality of plenums and to the controller, to selectively control the level of negative pressure applied and the rate at which the negative pressure is applied and removed.

32. An apparatus for underfilling a gap between a plurality of integrated circuit chips and a plurality of substrates with an encapsulant material to encapsulate a plurality of electrical connections formed therebetween, comprising:
a plurality of multi-legged vacuum tools respectively positioned adjacent the plurality of substrates and having legs thereof extending along at least two peripheral edges of each chip, each tool having walls defining a partially enclosed plenum, whereby the application of negative pressure to each plenum creates a pressure drop between the gap and the plenum to cause flow of encapsulant into the gap between each chip and substrate from a location on each substrate along at least one peripheral edge of each chip;
a mounting member supporting the plurality of multi-legged tools, the mounting plate having holes communicating with the respective plenums and configured to receive the plurality of chips mounted on the substrates; and
a plurality of vacuum passages communicating with the respective plenums of said tools to communicate negative pressure to the respective gaps and draw the encapsulant material into the gaps.

33. The apparatus of claim 32, wherein said mounting member is a plate and said vacuum passages are integrally formed in said plate.

34. The apparatus of claim 32, wherein said tools include fluid couplings communicating with the plenums and said vacuum passages are contained in separate conduits connected to said fluid couplings.

35. The apparatus of claim 32, wherein each tool has multiple ports and corresponding multiple vacuum passages operatively connected to a controller, said controller operable to apply different levels of negative pressure to different passages depending on the location of the corresponding port relative to the plenum.

36. The apparatus of claim 32, wherein each tool has at least two vacuum passages communicating with different portions of the plenum thereof, and the vacuum passages are formed in a wall of the tool located opposite from and generally parallel to the substrate.

37. The apparatus of claim 32, wherein each tool has at least two of said vacuum passages located in at least one outer wall of the tool which is oriented perpendicular to the substrate.

38. The apparatus of claim 32, wherein each tool includes at least one internal wall to divide the plenum into more than one partition, with at least one of said vacuum passages communicating with each partition and negative pressure is applied to each of the partitions to cause underfilling of the encapsulant material.

39. The apparatus of claim 32, wherein each plenum includes an insert oriented generally parallel with the corresponding substrate, to divide the plenum into upper and lower regions, the insert having a plurality of holes formed therein, and wherein negative pressure applied to the upper region is conveyed to the lower region via the holes in the insert and the holes are sized and shaped to achieve a desired distribution of the negative pressure from the upper region to the lower region of the plenum.

40. A method of simultaneously underfilling a plurality of electronic components using a vacuum apparatus including a plurality of multi-legged tools mounted adjacent a corresponding plurality of holes in a mounting member, the electronic components comprised of electronic circuit chips respectively mounted to substrates with gaps formed between each chip and corresponding substrate, the method comprising:
dispensing encapsulant material along at least one peripheral edge of each chip;
positioning the electronic components within the holes such that each gap communicates with a plenum of each tool, and with at least two legs of each tool extending along two corresponding edges of each chip, and
communicating negative pressure to the plenum of each tool to draw the encapsulant into the gap of each chip.

41. The method of claim 40, further comprising:
allowing negative pressure leakage from each plenum through a space formed between each tool and an edge of the chip.

42. The method of claim 40, further comprising:
communicating the negative pressure through separate conduits coupled to each plenum.

43. The method of claim 40, further comprising:
communicating the negative pressure through passages formed in the mounting member and communicating with each plenum.

44. The method of claim 40, further comprising:
communicating different levels of negative pressure to different portions of each plenum.

45. An apparatus for assisting in the underfilling of an area between an integrated circuit chip and a substrate, comprising:
a negative pressure source;
a plenum having a plurality of chambers and a bottom having a stepped channel, wherein the plurality of chambers are in fluid communication with the channel, and selectively in fluid communication with the negative pressure source and atmospheric pressure; and
a controller for coupling the chambers of the plenum to the negative pressure source and sequentially coupling the chambers to atmospheric pressure during operation.

46. The apparatus of claim 45, wherein the channel of said plenum mates with a portion of the top of the chip while spacing the plenum from the edge of the chip in operation to form a fluid passageway therebetween.

47. The apparatus of claim 45, wherein the bottom of the plenum further comprises a gasket for mating with the chip and the substrate in operation.

48. The apparatus of claim 45, wherein the plenum is substantially “L” shaped.

49. The apparatus of claim 45, wherein the plenum is substantially “U” shaped.

50. The apparatus of claim 45, wherein the chambers of the plenum are bores.

51. The apparatus of claim 45, wherein the plenum further comprises first and second legs wherein a chamber located at an outer end of said first or second leg is smaller than a chamber located inwardly therefrom.

52. A method of underfilling an area between an integrated circuit chip and a substrate comprising the steps of:
locating a multi-chambered plenum along at least two edges of the chip, the plenum being stepped from the two edges of the chip while in substantial engagement with a top portion of the chip forming a fluid passageway having a pair of inlets coupled to atmospheric pressure, said fluid passageway being in a fluid communication with the chambers of the plenum and the area between the chip and the substrate;
dispensing an underfill material along one or more edges of the chip;
applying a negative pressure to the chambers of the plenum;
sequentially venting the chambers to atmosphere.

53. A method of underfilling an area between an integrated circuit chip and a substrate comprising the steps of:
locating a multi-chambered plenum along two edges of the chip, the plenum being in engagement with the substrate and a top portion of the chip while being spaced from the two edges of the chip;
dispensing an underfill material along two other edges of the chip;
applying a negative pressure to the chambers of the plenum;
sequentially venting the chambers of the plenum beginning with the chambers located closest to the edges of the chip wherein the underfilled material was dispensed.

54. The method of claim 53, wherein the sequential venting is time based.

55. The method of claim 53, wherein the step of sequentially venting the chambers is done in pairs.

56. A method of underfilling an area between an integrated circuit chip and a substrate comprising the steps of:
locating an “L” shaped plenum, having first and second legs, each leg of the plenum having a plurality of chambers, along two edges of the chip, the plenum being in engagement with the substrate and a top portion of the chip while being spaced from the two edges of the chip;
dispensing an underfill material along two other edges of the chip;
applying a negative pressure to the chambers of the plenum;
sequentially venting the chambers of each leg of the plenum beginning with the chamber located the farthest from the other leg.

57. The method of claim 56, wherein the sequential venting is time based.

58. The method of claim 56, wherein the venting of a chamber in the first leg of the plenum is coupled with the venting of a chamber in the second leg of the plenum.

59. A method of underfilling an area between an integrated circuit chip and a substrate comprising the steps of:
locating a “U” shaped multi-chambered plenum along at least portions of three edges of the chip, the plenum being in engagement with the substrate and a top portion of the chip while being spaced from the two edges of the chip;
dispensing an underfill material along an edge of the chip;
applying a negative pressure to the chambers of the plenum;
sequentially venting the chambers of the plenum beginning with these chambers located closest to the edges of the chip wherein the underfilled material was dispensed.

60. The method of claim 59, wherein the sequential venting is time based.

61. A method of underfilling an area between an integrated circuit chip and a substrate comprising the steps of:
locating a multi-chambered plenum along at least two edges of the chip, the plenum being in engagement with the substrate and a top portion of the chip while being spaced from the two edges of the chip;
dispensing an underfill material along two other edges of the chip;
applying a negative pressure to the chambers of the plenum; and
venting a chamber to atmosphere once the underfill material has reached the edge of the chip adjacent to the chamber.

62. The method of claim 61, wherein the plenum is substantially “L” shaped.

63. The method of claim 61, wherein the plenum is “U” shaped.

64. The method of claim 61, wherein the step of venting a chamber to atmosphere includes the step of ramping the chamber from a vacuum to atmospheric pressure.

65. The method of claim 61, wherein step (d) further includes sensing the underfill material at the edge of the chip adjacent to the chamber.

66. The method of claim 65, wherein the step of sensing includes utilizing a fiber optic sensor.
